(19) United States
(12) Patent Application Publication
(10) Pub. No.: US 2025/0159031 A1
(43) Pub. Date: May 15, 2025

(54) DOWNLOADING OF A WEB PAGE OPTIMIZED FOR EVENT TRAFFIC PEAKS

(71) Applicant: Orange, Issy-les-Moulineaux (FR)

(72) Inventors: Hervé MARCHAND, CHATILLON CEDEX (FR); Olivier GASTE, CHATILLON CEDEX (FR)

(21) Appl. No.: 18/940,694

(22) Filed: Nov. 7, 2024

(30) Foreign Application Priority Data
Nov. 9, 2023 (FR) FR2312251

(51) Int. Cl. H04L 65/61; H04L 43/0876

(52) U.S. Cl. CPC H04L 65/61; H04L 43/0876

(57) ABSTRACT

A method for access by a client to a web service deployed on a server through a telecommunications network. The method includes: receipt of a request designating a page referencing a set of elements called dynamic elements, at least some of the dynamic elements corresponding to audio-video contents, determination of a traffic peak associated with at least one audio-video content, and emission to the client of a specific page linked to the at least one audio-video content, in response to the request.

### CROSS-REFERENCE TO RELATED APPLICATIONS

This application claims foreign priority to FR2312251, filed Nov. 9, 2023. The contents of the priority application are incorporated by reference herein in its entirety.

### BACKGROUND

### Field

The present invention relates to the downloading from a server to a telecommunications client of a web page referencing a set of elements that must be dynamically determined. It applies particularly to web pages of web applications that can cope with significant traffic peaks, such as “web TV” type applications.

### Description of the Related Technology

A Web TV type application aims to offer the usual services of a connected television from a browser that can connect to a website. A user of a computer or any telecommunications device (such as a digital tablet, a Smartphone, etc.) can thus connect to the “web TV” application and view a chosen audio or audio-video program via his browser.

“Web TV” type applications thus aim to offer a package of audio and/or video contents to users, these contents being able to be live streamed or delayed in the form of videos on demand.

Such an application can aggregate contents from different sources.

The content offering can vary over time, in particular because audio-video contents are inherently linked to the news, but also because content providers can regularly update their offering for marketing reasons.

Also, the content offering can vary depending on the users. These can be registered with the application and have access to contents that may therefore depend on their profile, including channels or packages to which they have subscribed.

It therefore appears that the application cannot present a static web page, at least as a home page, but a page dynamically built according to the moment at which the request is received and to the user from whom this request emanates.

The web page is then typically made up of a minimal static frame and references to elements that are dynamically incorporated into the page, in order to build this web page on demand so that it can be produced on the man-machine interface of the user's browser.

These elements can in particular be determined by computer code (typically in JavaScript language) incorporated or referenced in the frame of the web page. This computer code is intended to retrieve the dynamic elements in databases as function for example of contextual parameters (user identifier, current time, etc.) and of the logic implemented by the computer code.

When it receives a request from a user's client (telecommunications terminal, computer, etc. hosting a web browser), the server hosting the web application can return the web page frame, leaving it up to the client to execute the computer code and to determine then download the various constituent elements of the web page, in order to produce it on the screen of the terminal.

However, a “web TV” type application can have a commercial purpose and therefore obtain the greatest possible visibility on the Web. This visibility requires good referencing with the various search engines.

Therefore, the server hosting the web application cannot return only this web page frame and the computer code because they would not be correctly processed by the search engines. In particular, these are not adapted to execute the computer code and could therefore not retrieve the various constituent elements of the web page. Therefore, the search engines could not take into account the content of these pages and therefore could not reference them correctly.

The web page must therefore be built by the server and transmitted to the clients, once built, that is to say after integration of the different dynamically determined constituent elements.

This type of operation is generally called SSR for Server Side Rendering.

This is a technique used in web development that consists in using scripts on a web server that produces a personalized response for each user (client) demand on the website. The scripts can be written in one of the available server-side scripting languages (such as JavaScript, PHP, Python, etc.). The SSR is distinguished from the client side rendering, in which embedded scripts are executed on the client side in a web browser, but the two techniques are often used together. The alternative to either or both types of scripts is that the web server itself provides a static web page.

This technique therefore places a significant load on the server, which must be able to build web pages on the fly for each request received from a user. Conventionally, the servers are sized to cope with the load induced by this operation. However, in the context of a Web TV type application, as previously explained, the server must cope with a high variability in the number of requests over time and with extremely significant peaks.

For example, before an important event (speech by the President of the Republic, start of a sports competition match, announcement of a disaster, etc.), the server can receive a number of requests several tens of times higher than the rating (a few minutes before).

Sizing the server based on these load peaks would be theoretically possible, but would require on the one hand predicting the maximum intensity of these peaks, and further having resources that are much too significant for the rating. To the extent that these load peaks can be relatively exceptional or in any case infrequent, this oversizing would be non-optimal in terms of costs for the server operator and detrimental in ecological terms.

There is therefore a need to improve the current proposals of the state of the art.

### SUMMARY

The invention aims to efficiently manage the traffic peaks on the servers deploying web applications, in particular of the “web TV” type, having a referencing constraint, and by avoiding oversizing the servers.

For these purposes, according to a first aspect, the present invention can be implemented by a method for access by a client to a web service deployed on a server through a telecommunications network, said method including:
receipt of a request designating a page referencing a set of elements called dynamic elements, at least some of said dynamic elements corresponding to audio-video contents,
determination of a traffic peak associated with at least one audio-video content,
emission to said client of a specific page linked to said at least one audio-video content, in response to said request.

Thus, the computational work that the server must deploy to transmit a requested page can be dynamically adapted to the traffic on the server, by offloading the requests to a specific page that is less demanding in terms of computational load.

According to preferred embodiments, the invention comprises one or several of the following characteristics that can be used separately or in partial combination with each other or in total combination with each other:
said specific page is adapted to reference said at least one audio-video content, and, possibly, said requested page. Thus, the user only needs one action to trigger the downloading of the content associated with the traffic peak, and in which he is statistically most interested.
said specific page is a static page including no dynamic element. Thus, the computational work necessary for the server is reduced to a minimum, which allows it to cope with the traffic peak with a controlled resource (CPU and memory).
said determination comprises a monitoring of the traffics associated with a set of audio-video contents, and a detection of a traffic peak among said traffics. The server can thus adapt dynamically to the fluctuations in the load and react as soon as a traffic peak appears.
said detection is based on a comparison of said traffics with a determined threshold.
processing operations corresponding to said determination of a traffic peak are triggered prior to said receipt of said request. It is thus possible to pool the determination of the peak for several requests.

Another aspect of the invention relates to a server accessible to a client through a telecommunications network, including at least one processor adapted to implement:
a receipt of a request designating a page referencing a set of elements called dynamic elements, at least some of said dynamic elements corresponding to audio-video contents,
a determination of a traffic peak associated with at least one audio-video content,
an emission to said client of a specific page linked to said at least one audio-video content, in response to said request.

Another aspect of the invention relates to a computer program able to be implemented on a web server, the program comprising code instructions which, when it is executed by a processor, carries out the steps of the method as previously defined.

Another aspect of the invention relates to a data medium on which at least one series of program code instructions has been stored for the execution of a method as previously defined.

Other characteristics and advantages of the invention will become apparent upon reading the following description of one preferred embodiment of the invention, given by way of example and with reference to the appended drawings.

### BRIEF DESCRIPTION OF THE DRAWINGS

FIG. 1 illustrates a context of implementation of a method and of a server, according to embodiments of the invention,

FIG. 2 illustrates one example of a graphical interface that can be displayed by a screen associated with a client, corresponding to a requested page, according to one embodiment of the invention,

FIG. 3 schematizes a timing diagram according to one embodiment of the invention.

FIG. 4 illustrates one example of a graphical interface that can be displayed by a screen associated with a client, corresponding to a specific page, according to one embodiment of the invention.

### DETAILED DESCRIPTION OF CERTAIN ILLUSTRATIVE EMBODIMENTS

FIG. 1 illustrates one context of implementation of a server S that can host a web application A.

This server S is accessible to clients through a telecommunications network N.

This telecommunications network can typically be composed of several interconnected networks, in particular an access network allowing the clients to connect to a main network (itself consisting of an interconnection of sub-networks) or “backbone”.

The clients can be locally connected to a local area network, LN, for example a wireless local area network, allowing them to access a gateway P to the access network. This wireless local area network, commonly called WLAN for Wireless Local Area Network, can comply with the Wi-Fi protocols, or wifi, as specified in the normative documents of the IEEE of the 802.11 family (or ISO/IEC 8802-11).

The client can also directly access the access network, for example a third, fourth, fifth generation cellular network (3G/4G/5G) for example.

Clients can be of different natures, their common feature being that they have means allowing the connection to the network. These are essentially radiocommunication components and electronic and computer components for implementing the protocol stacks necessary for managing the protocols associated with the network and for receiving and emitting data packets.

FIG. 1 represents three types of clients: a computer ORD, a mobile communication terminal MOB, and a connected television set TV.

The mobile terminal MOB is typically a Smartphone or a digital tablet. The computer can be a desktop or a laptop.

The television set TV can be connected natively or through an associated device such as an HDMI stick connected to the television set.

One example of an external device communicating with a television set TV is Chromecast. The Chromecast is a real-time multimedia stream player device (multimedia gateway) developed and marketed by Google. The device plugs into the HDMI port of a television set and communicates, via Wi-Fi connection, with another device connected to the Internet (computer, Smartphone, tablet, etc.), in order to display on the television set the multimedia content received from an application compatible with Google Cast technology, from Google Chrome browser present on a computer, or from some Android devices.

In the illustrative example of FIG. 1, the clients ORD and TV clients can access the web application A via the local area network LN and the gateway P. The client MOB accesses the web application A directly through the telecommunications network N. These two access types are illustrative and essentially aim to show the diversity of the possible connections between a client and the web application A.

The clients have software tools adapted to allow the user to connect to a web application and to view a content transmitted from this web application. Particularly, in the case of a web application of the “Web TV” type, the software tool (commonly called “web browser”) is adapted to allow the production of audio or audio-video content on a man-machine interface associated with the client (screen of the client, external screen connected to the client, etc.)

The audio or audio-video contents comprise live stream contents that can be linked to television or radio broadcasting channels, etc. It can also be content on demand (podcast, video on demand, VoD, etc.).

Web application A is intended to provide, upon request from the clients, web pages referencing different elements.

These elements can correspond to areas of the web page, the content of which can be individually determined. For example, in the case of a “web TV” type application, the elements can correspond to channels, specific video contents, menus, advertising spaces, etc.

The elements can be associated with both a visual or graphical representation and a behavior, in particular when it is pointed to or selected by the user.

For example, video content can be highlighted or animated differently when the user points to it (for example using a mouse or a remote control), and be triggered in full screen when it is selected.

The selection of other elements can result in other actions, such as the opening of a new web page.

Particularly, the first page, or home page, can thus be dynamically determined. The web application can also contain dynamically determined pages and static pages (pure HTML code). Some pages can also be a mix of both, that is to say include static elements and elements that must be dynamically determined.

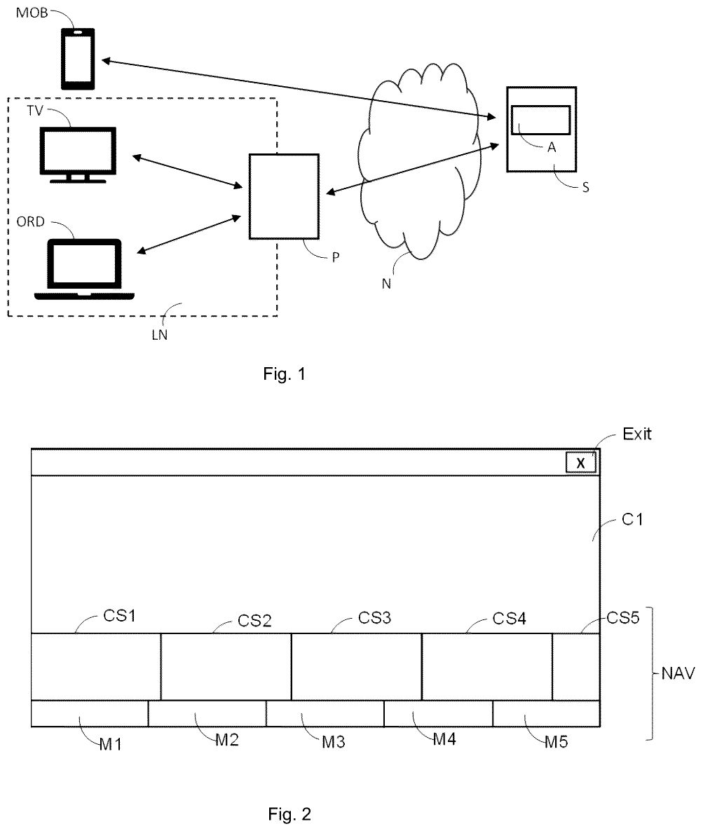

FIG. 2 illustrates one example of a graphical interface that can be displayed by a screen associated with a client. This example page can be a home page.

This graphical interface can display, concomitantly, video content or stream in an area C1, and a navigation area NAV allowing interactions with the user of the terminal and in particular allowing changing the video stream to be displayed in the area C1.

The navigation area NAV includes a set of areas CS1, CS2, CS3, CS4, CS5 for displaying secondary video streams or contents. These secondary contents can for example correspond to other television channels.

The selection of a secondary area can trigger the display of the secondary video content in the main area C1. The content previously displayed in this main area C1 can then be displayed in a secondary area. The user can thus zap from one video content to another by means of this graphical interface.

The navigation area can also include menus M1, M2, M3, M4, M5, allowing other navigation options, for example changing the multimedia content source: this can for example involve connecting to another content server SC, retrieving locally stored multimedia contents, etc.

The graphical interface can include other elements not represented in the figure: menus, drop-down menus or others, accessible for example by means of the selection of a menu M1, M2, ML3, M4, M5, or a key on a remote control associated with the terminal 10, etc. These elements can allow access to other options, for example to all the available television channels.

As previously specified, elements of this page can be dynamically determined in order to reflect the different contents, in particular audio-video contents, available and accessible to the user according to his profile and to the current time. The web page therefore references these elements that must be determined dynamically, and which will subsequently be called “dynamic elements”.

The web page can also include static elements, that is to say elements that do not have to be dynamically determined. These static elements do not depend on the news or on the user: they can be general information, graphical elements of the web page which are always present, of the CSS style sheet, etc.

According to one embodiment, the web page can be a canvas, or a frame, including very few static elements and mainly consisting of elements that must be determined dynamically (dynamic elements).

The referencing of elements in a web page can be done by any known means. Typically, these are tags or keywords from the HTML language (HyperText Markup Language).

Particularly, the referencing of an element that must be dynamically determined can be done by technical means allowing automatically triggering this determination. These technical means can be links to resources containing computer code.

This computer code can be scripts written in one of the available server-side scripting languages (such as JavaScript, PHP, Python . . . ).

It is intended to retrieve the dynamic elements in databases as a function, for example, of contextual parameters (user identifier, current time, etc.) and of the logic implemented by the computer code. Particularly, it can be intended to retrieve the visuals of a video transmission, of a television channel, of a menu, as well as the associated actions (allowing in particular triggering the downloading of the associated multimedia content from a content server).

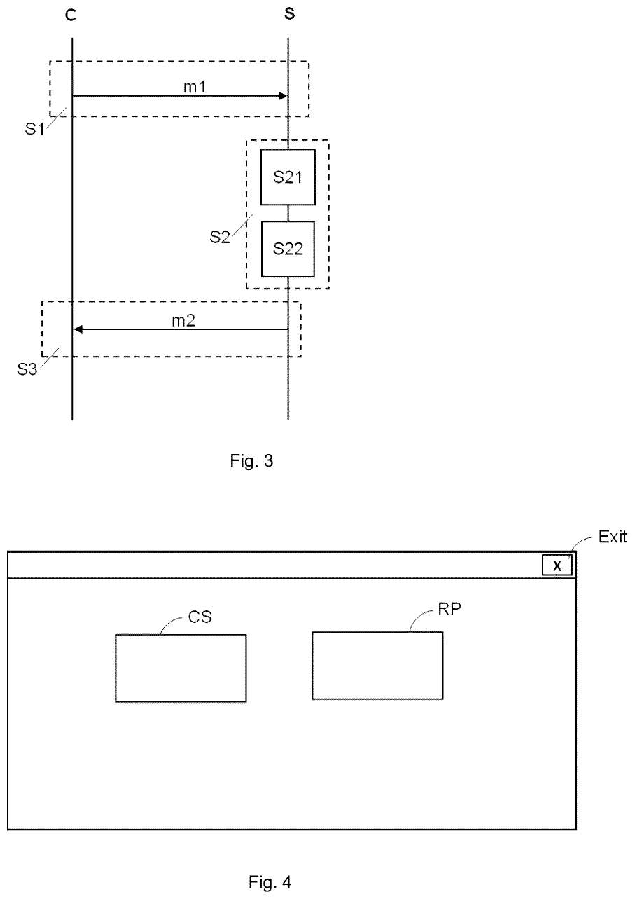

FIG. 3 schematizes a timing diagram according to one embodiment of the invention.

In a step S1, the client C transmits a request m1 to the server S. This request designates a requested page, available on this server. This page can for example be the home page. This can be designated by the URL (Unified Resource Locator) of the server S, or any other address previously provisioned on the client.

The request can comply with the HTTP protocol (HyperText Transfer Protocol).

It can in particular be a GET request of this HTTP protocol.

In a step S2, the server S can determine whether there is a traffic peak associated with one or several audio-video contents referenced in the requested page.

This determination can in particular comprise two sub-steps:
monitoring, S21, the traffics associated with a set of audio-video contents, among those referenced in the requested page (by the request m1), and
detecting, S22, a traffic peak among these traffics.

The server S can therefore set up a monitoring mechanism to count the number of clients requesting the contents referenced in the requested page.

The traffic can thus be calculated or estimated, for example in number of requests per unit time.

The traffics of the different referenced contents (or of a sub-part) can be compared to a determined threshold.

This threshold can be determined in order to allow the detection of the traffic peaks that may impact the ability of the server to process the requests m1 of the clients in order to determine the dynamic elements referenced in the requested pages.

Concretely, this threshold can be sized in order to discriminate normal traffics on a content server and exceptional traffics for which the server is normally not sized (its sizing would be, as previously explained, an over-sizing having numerous drawbacks in terms of costs and ecological impact).

For example, the period corresponding to the start of a major sports competition, to a speech by a President of the Republic, to the announcement of a disaster, etc. can be events likely to generate a traffic peak for the corresponding audio-visual content.

In general, only one audio-video content generates a traffic peak at some point, but it may happen that several contents experience a traffic peak in the same time window. This can be the case in particular if the same event is streamed by several television channels.

The traffic can be periodically monitored, S21, for example at regular intervals. Upon receipt of a request, the latest measurement or estimation is then taken into account. According to another embodiment, the traffic of the server S is measured or estimated upon receipt of a request m1 (for example by analysis of a log file).

In other words, processing operations corresponding to steps S21 and S22 can be deployed before the receipt of a request, m1. The processing operation deployed upon receipt of this request consists in checking a state of the server, as previously determined, that is to say there is currently a traffic peak.

In a step S3, in the case where a traffic peak is detected for at least one content, the server S emits, m2, to the client C a specific page, in response to the request m1 received from this client. This specific page is transmitted instead of the page requested by this client, and is linked to the content(s) associated with the detected traffic peak(s).

This specific page aims to free the server from having to determine the different dynamic elements referenced in the requested page. It therefore aims to avoid a significant computational task for the server which, as seen, can pose problems during a traffic peak that generates a significant load for the content server.

Also, according to one embodiment, this specific page can be a static page, which therefore does not include any dynamic elements. This static page requires a minimum processing operation for the server.

In such embodiment, the static page can be built independently of the requests, for example upon detection of a traffic peak. This page is then stored on the server S and transmitted to the clients that issue a request to a page referencing the content corresponding to this traffic peak.

The specific page can be adapted to reference the audio-video content(s) and possibly the page requested during the request m1.

This specific page can be quite minimalist and, for example, propose only these two options. The page is then intended to allow the user of the client C to either access the content associated with the traffic peak since, statistically, the probability that he is interested in this content is very high, or access the requested page.

With a high probability (statistically function of the significance of the traffic peak), the client C will not select the access to the initially requested page. Thus, the corresponding task of determining the dynamic elements referenced in this page will not be triggered. This results in a saving of resources, on the server side, which is all the more significant as the traffic peak is high.

FIG. 4 illustrates a specific page as it can be produced on a man-machine interface of a client C.

This page includes an element CS corresponding to the content associated with the traffic peak. This element can be a simple text, or an image representative of the content.

The page can also include an element RP corresponding to the requested page. This element can also be a simple text, or an image representative of the requested page. If the requested page is the home page, it can be a static view of this home page, for example.

The elements also include links which, when activated by the user of the client C, trigger the access to the corresponding resource: audio-video content (element CS) or downloading of the requested page (element RP).

According to one embodiment, just like the request message m1, this response message m2 containing the specific page can comply with the HTTP protocol. In accordance with the protocol, a set of messages m2 can be transmitted in order to transmit the various constituent elements of the web page.

Thus, outside of any traffic peak, the behavior of the server S is unchanged and remains the nominal operation.

When a traffic peak appears, its behavior is modified and can enter into an operation that can be considered degraded in order to be able to cope with the traffic and I the oad increase. This degradation of the quality of service is however balanced by the advantages in terms of server sizing, and therefore cost and ecological cost.

During a traffic peak, it is possible that a search engine retrieves a specific web page. In this case, it will not be able to correctly reference the web page. However, the probability that a search engine will send a request to the server during a peak in its activity is relatively low. Furthermore, search engines regularly send requests to the same page, so that the impact of poor referencing on a request is minimized on a set of requests.

Of course, the present invention is not limited to the examples and embodiment described and represented, but is defined by the claims. It is in particular subject to numerous variants accessible to those skilled in the art.

What is claimed is:

1. A method for access by a client to a web service deployed on a server through a telecommunications network, the method including:
receiving a request designating a page referencing a set of elements called dynamic elements, at least some of the dynamic elements corresponding to audio-video contents,
determining a traffic peak associated with at least one audio-video content,
emitting to the client of a specific page linked to the at least one audio-video content, in response to the request.

2. The method according to claim 1, wherein the specific page is adapted to reference the at least one audio-video content, and, possibly, the requested page.

3. The method according to claim 1, wherein the specific page is a static page including no dynamic element.

4. The method according to claim 1, wherein the determining comprises a monitoring of the traffic associated with a set of audio-video contents, and a detection of a traffic peak among the traffics.

5. The method according to claim 4, wherein the detection is based on a comparison of the traffics with a determined threshold.

6. The method according to claim 1, wherein processing operations corresponding to the determining of a traffic peak are triggered prior to the receiving of the request.

7. A server accessible to a client through a telecommunications network, including at least one processor adapted to implement:
a receipt of a request designating a page referencing a set of elements called dynamic elements, at least some of the dynamic elements corresponding to audio-video contents,
a determination of a traffic peak associated with at least one audio-video content, and
an emission to the client of a specific page linked to the at least one audio-video content, in response to the request.

8. A computer program able to be implemented on a server, the computer program comprising program code instructions which, when executed by a processor, carries out the method defined in claim 1.

9. A non-transitory data medium on which at least one series of program code instructions has been stored for execution of the method according to claim 1.
